(19) United States
(12) Patent Application Publication
(10) Pub. No.: US 2005/0009460 A1
(43) Pub. Date: Jan. 13, 2005

(54) Combination fish scaler and knife

(76) Inventor: Kenneth M. Weaver, Williamstown, NJ (US)

Correspondence Address: John B. Dickman, III, Suite 1203, 2001 Jeff Davis Hwy., Arlington, VA, 22202, US

(21) Appl. No.: 10/616,951

(22) Filed: Jul. 11, 2003

(51) Int. Cl. A22C 25/02

(52) U.S. Cl. 452/105

(57) ABSTRACT

A combination fish scaling and dressing device having a handle portion with roughened outer surfaces and an extendible and retractable knife enclosed within said handle, said knife being manually retracted and extended by a thumb or finger activated button attached to said blade and extending through the housing. A modification has an open blade fixed in the handle with a roughened surface on one or more portions of the handle.

### BACKGROUND OF THE INVENTION

This invention relates to a combination fish scaler and knife, and has for its object to present a unitary device for fishermen, sportsmen and others so that a single tool will combine to perform a multitude of tasks.

Retractable knives and fish scalers have been known for some time, but as of now, no one has combined the two into a simple, self-contained structure that will perform all of the tasks associated with the preparation of fish from the catching to the cooking thereof.

With the foregoing and other objects in the view as the nature of the invention will be better understood, the same comprises the novel form, combination and arrangement of parts hereinafter more fully described, shown in the accompanying drawing and claims.

In the drawing wherein like reference characters indicate corresponding parts in both of the views:

### DESCRIPTION OF THE DRAWINGS

FIG. 1 shows a plan view of the device with the blade in its extended position.

FIG. 2 shows a plan view of the device as in FIG. 1 but with its blade retracted.

FIG. 3 is a side view of the device showing the slide operator for extending and retracting the blade.

### DESCRIPTION OF THE PREFERRED EMBODIMENT

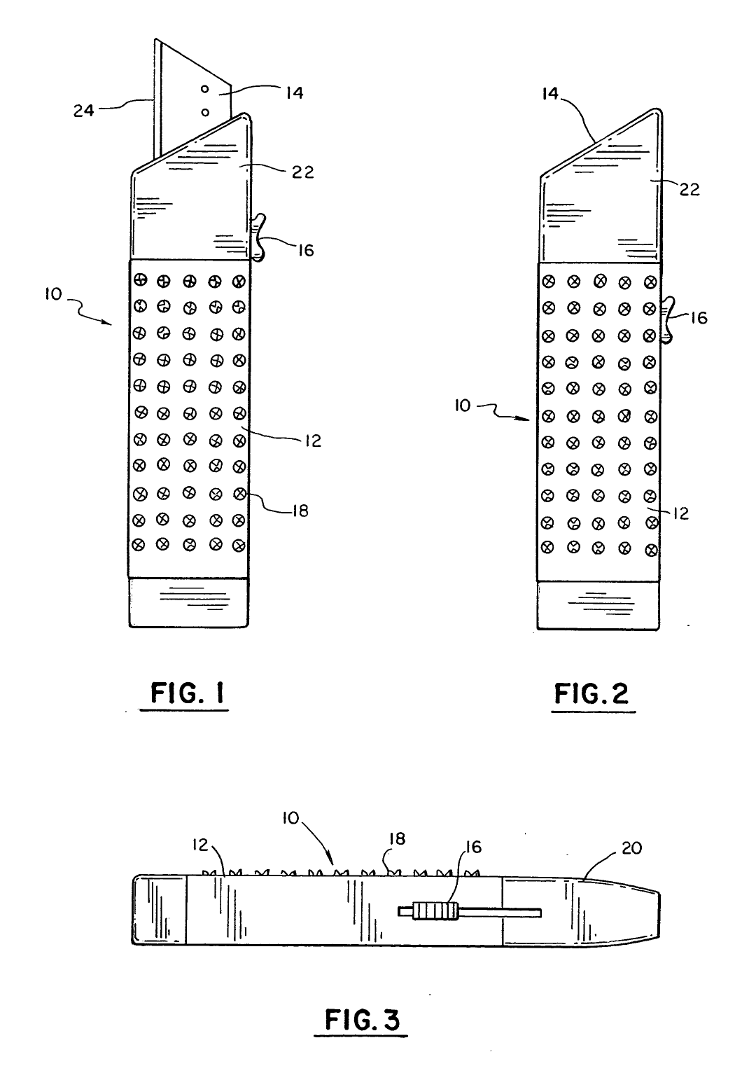

The combined knife and fish scaler as shown in FIG. 1 is indicated generally by reference numeral 10. A housing or case 12 contains a blade 14 activated by a thumb or finger slide 16. The slide 16 is connected to the blade 14 within the housing 12 (not shown) in any conventional manner.

On the outer surface of the housing 12, a fish scaling surface 18 is provided. This surface can be formed on one or both sides of the housing 12, and can be of any suitable design or configuration.

The housing 12 has an integral elongated portion 20 extending from the main body and supporting the back edge 22 of blade 14. The cutting edge of blade 14 is indicated at 24.

In use, the blade 14 will be in the retracted portion when the fish cleaning begins. The preferred method of cleaning a fish is to lay the fish on a flat surface, hold it down with one hand and move a knife blade back and forth from the fishes' head to its tail, removing as many scales with each pass until the scales are all removed. One problem with this method, especially with novice fishermen and cooks, is the possibility of seriously cutting one's self if the knife should slip or the fish or the hand should slip while holding the fish on the flat surface. After the fish is scaled, the knife is then used to remove the head, tail and entrails.

In the present device, a knife and scaling surface is combined to form a safe, unitary tool, which is used to scale and dress the fish with a greatly reduced chance of injury to all users, novice or experienced. The present device has a retractable knife blade enclosed within a handle, the outer surfaces of the handle having a series of roughened protrusions (as shown in the drawings) any type of protrusions will suffice, if they will adequately remove the scales. These protrusions will not seriously injure the user if the fish should slip out of the scaling position, at most a slight abrasion, whereby using a knife blade could result in deep cuts on the hands.

After the scaling is completed, the retraced knife blade is manually moved into its extended position as shown in FIG. 1 and then used to remove the head, tail and entrails of the fish.

A modification of the device would have an open blade fixed in the handle rather than having a slidable blade as shown in the drawings.

As many changes could be made in the above-construction and many apparently widely different embodiments of this invention could be made without departing from the scope thereof, it is intended that all matter contained in the above description or shown in the accommpanying drawings shall be interpreted as illustrative and not in a limited sense.

It is also to be understood that the language used in the following claims is intended to cover all of the generic and specific features of the invention herein described and all statements of the scope of the invention which, as a matter of language, might be said to fall therebetween.

1. A combination fish scaling and dressing device, comprising a handle, a retractable and extendible blade in said handle, the exterior portions of said handle having roughened surfaces thereon.

2. A combination fish scaling and dressing device, as set forth in claim 1 in which said handle has blade supporting and protecting means extending therefrom.

3. A combination fish scaling and dressing device, as set forth in claim 1 in which said roughened surfaces on said handle portion comprise a series of individually attached scaling members.

4. A combination fish scaling and dressing device, as set forth in claim 1 in which said roughened areas on said handle are formed integrally with said handle.

5. A combination fish scaling and dressing device as set forth in claim 1 in which said retractable and extendable blade is activated by a thumb slide on said handle.

6. A combination fish scaling and dressing device comprising a handle and a fixed open blade, and a roughened area on a portion of said handle.
